(19) United States
(12) Patent Application Publication
(10) Pub. No.: US 2003/0151513 A1
(43) Pub. Date: Aug. 14, 2003

(54) Self-organizing hierarchical wireless network for surveillance and control

(76) Inventors: Falk Herrmann, Mountain View, CA (US); Andreas Hensel, Egmating (DE); Arati Manjeshwar, Sunnyvale, CA (US); Mikael Israelsson, Umea (SE); Johannes Karlsson, Umea (SE); Jason Hill, Oakland, CA (US)

Correspondence Address: KENYON & KENYON, ONE BROADWAY, NEW YORK, NY, 10004, US

(21) Appl. No.: 10/301,394

(22) Filed: Nov. 21, 2002

Related U.S. Application Data
(60) Provisional application No. 60/347,569, filed on Jan. 10, 2002.

(51) Int. Cl. H04B 7/00

(52) U.S. Cl. 340/573.1; 370/254; 370/310

(57) ABSTRACT

A wireless network is described including a cluster network and a sensor/actuator network arranged in a hierarchical manner with the cluster head network. The cluster head network includes at least one cluster head and the sensor/actuator network includes a plurality of sensor/actuator nodes arranged in a plurality of node levels.

### CROSS-REFERENCE TO RELATED APPLICATIONS

This application claims the benefit of provisional application Serial No. 60/347,569 filed on Jan. 10, 2002 and is related to application entitled “Protocol for Reliable, Self-Organizing, Low-Power Wireless Network for Security and Building Automation” filed on Nov. 21, 2002, both of which are incorporated herein by reference.

### FIELD OF THE INVENTION

The present invention relates to a wireless network of sensors and actuators for surveillance and control, and a method of operation for the network.

### BACKGROUND

Wire-based networks may be applied in security systems, building automation, climate control, and control and surveillance of industrial plants. Such networks may include, for example, a large number of sensors and actuators arranged in a ring or tree configuration controlled by a central unit (e.g. a panel or base station) with a user interface.

A substantial amount of the cost of such systems may arise due to the planning and installation of the network wires. Moreover, labor-intensive manual work may be required in case of reconfigurations such as the installation of additional devices or changes in the location of existing devices.

Battery-powered versions of the aforementioned sensors and actuators may be deployed with built-in wireless transmitters and/or receivers, as described in, for example, U.S. Pat. Nos. 5,854,994 and 6,255,942. A group of such devices may report to or be controlled by a dedicated pick-up/control unit mounted within the transmission range of all devices. The pick-up/control unit may or may not be part of a larger wire-based network.

Due to the RF propagation characteristics of electromagnetic waves under conditions that may exist inside buildings, e.g. multi-path, high path losses, and interference, problems may arise during and after the installation process associated with the location of the devices and their pick-up/control unit. Hence, careful planning prior to installation as well as trial and error during the installation process may be required. Moreover, due to the limited range of low-power transceivers applicable for battery-powered devices, the number of sensors or actuators per pick-up/control unit may be limited. Furthermore, should failure of the pickup/control unit occur, all subsequent wireless devices may become inoperable.

### SUMMARY OF THE INVENTION

The present invention relates to a wireless network of sensors and actuators for surveillance and control, and a method of operation for the network. The sensors and actuators may include, for example, smoke detectors, motion detectors, temperature sensors, door/window contacts, alarm sounders, or valve actuators. Applications may include, but are not limited to, security systems, home automation, climate control, and control and surveillance of industrial plants. The system may support devices of varying complexity, which may be capable of self-organizing in a hierarchical network. Furthermore, the system may be arranged in a flexible manner with a minimum prior planning in an environment that may possess difficult RF propagation characteristics, and may ensure connectivity of the majority of the devices in case of localized failures.

According to an exemplary embodiment of the present invention, the network may include two physical portions or layers. The first physical layer may connect a small number of relatively more complex devices to form a wireless backbone network. The second physical layer may connect a large number of relatively less complex low-power devices with each other and with the backbone nodes. Such an arrangement of two separate physical layers may impose less severe energy constraints upon the network.

To allow for reliable operation and scalability, the central base station may be eliminated so that a single point of failure may be avoided. The system may instead be controlled in a distributed manner by the backbone nodes, and the information about the entire network may be accessed, for example, any time at any backbone node. Upon installation, the network may configure itself without the need for user interaction and for detailed planning (therefore operating in a so-called “ad-hoc network” manner). In case of link or node failures during the operation, the system may automatically reconfigure in order to ensure connectivity.

Thus, an exemplary embodiment and/or an exemplary method according to the present invention may improve the load distribution, ensure scalability and small delays, and eliminate the single point of failure of the aforementioned ad-hoc network, while preserving its ability to self-configure and reconfigure.

### BRIEF DESCRIPTION OF THE DRAWINGS

FIG. 1 is a schematic drawing of a conventional ad-hoc wireless sensor network.

FIG. 2 is a schematic drawing of a hierarchical ad-hoc network without a central control unit.

### DETAILED DESCRIPTION

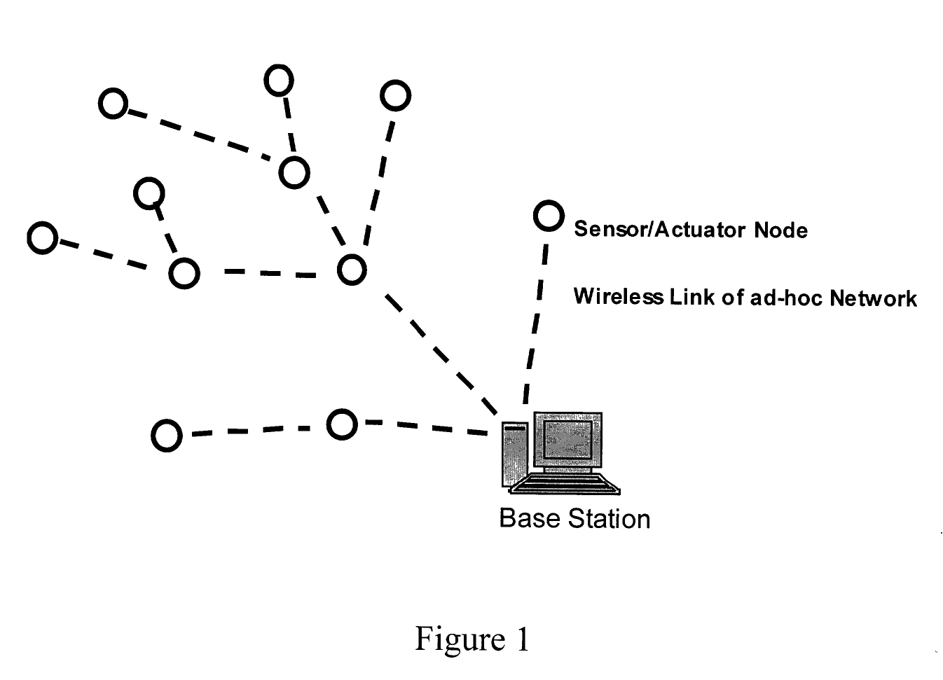

FIG. 1 shows a self-configuring (ad-hoc) wireless network of a large number of battery-powered devices with short-range wireless transceivers. As discussed in U.S. Pat. Nos. 6,078,269, 5,553,076, and 6,208,247 a self-configuring wireless network may be capable of determining the optimum routes to all nodes, and may therefore reconfigure itself in case of link or node failures. Relaying of the data may occur in short hops from remote sensors or to remote actuators through intermediate nodes to or from the central control unit (base station, see FIG. 1), respectively, while data compression techniques, and low duty cycles of the individual devices may prolong battery life. However, large systems with hundreds or even thousands of nodes may lead to an increased burden (e.g. battery drain) on those nodes closer to the base station which may serve as multi-hop points for many devices. Hence, the useful lifetime of the entire system may be reduced. Moreover, large networks may result in many hops of messages from nodes at the periphery of the network, which may lead to an increased average energy consumption per message as well as the potential for significant delays of the messages passing through the network. However, such delays may not be acceptable for time-critical applications, including, for example, security and control systems. Furthermore, if a central base station forms a single point of failure, the entire network may fail in case of the base station failure.

Device Types

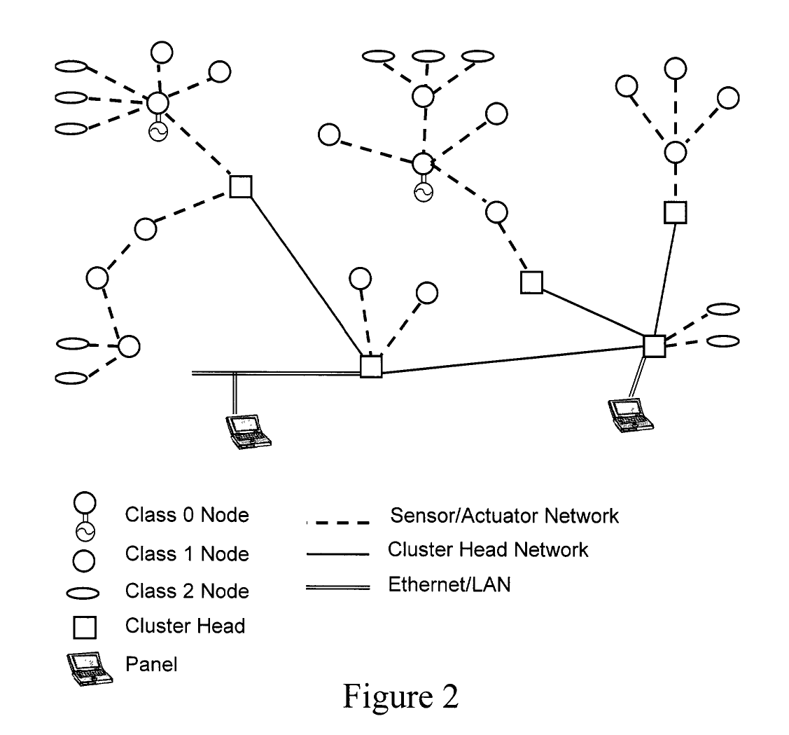

FIG. 2 is a schematic drawing of a hierarchical ad-hoc network absent a central control unit. The network may include devices of different types with varying complexity and functionality. In particular, the network may include a battery-powered sensor/actuator node (also referred to a Class 1 node), a power-line powered sensor/actuator node (also referred to as a Class 0 node), a battery-powered sensor/actuator node with limited capabilities (also referred to as a Class 2 node), a cluster head, and a panel. The network may also include, for example, a battery-powered node or input device (e.g., key fob) with limited capabilities, which may not be a “fixed” part of the actual network topology, or a RF transmitter device (also referred to as a Class 3 node). Each device type is more fully explained below.

Battery-Powered Sensor/Actuator Nodes (Class 1 Nodes)

Class 1 sensor/actuator nodes may be battery-powered devices that include sensor elements to sense one or more physical quantities, or an actuator to perform required actuations. The battery may be supported or replaced by an autonomous power supply, such as, for example, a solar cell or an electro-ceramic generator.

Through a data interface, the sensor or actuator may be connected to a low-power microcontroller to process the raw sensor signal or to provide the actuator with the required control information, respectively. Moreover, the microcontroller may handle a network protocol and may store data in both volatile and non-volatile memory. Class 1 nodes may be fully functional network nodes, for example, capable of serving as a multi-hop point.

The microcontroller may be further connected to a low power (such as, for sample, short to medium range) RF radio transceiver module. Alternatively, the sensor or actuator may include its own microcontroller interfaced with a dedicated network node controller to handle the network protocol and interface the radio. Each sensor/actuator node may be factory-programmed with a unique device ID.

Power-line powered sensor/actuator nodes (Class 0 nodes) Class 0 nodes may have a similar general architecture as Class 1 nodes, i.e., one or more microcontrollers, a sensor or actuator device, and interface circuitry, but unlike Class 1 nodes, Class 0 nodes may be powered by a power line rather than a battery. Furthermore, Class 0 nodes may also have a backup supply allowing limited operation during power line failure.

Class 0 nodes may be capable of performing similar tasks as Class 1 nodes but may also form preferential multi-hop points in the network tree so that the load on battery-powered devices may be reduced. Additionally, they may be useful for actuators performing power-intensive tasks. Moreover, there may be Class 0 nodes without a sensor or actuator device solely forming a dedicated multi-hop point.

Battery-Powered Sensor/Actuator Nodes with Limited Networking Capabilities

(Class 2 Nodes)

Class 2 nodes may have a general architecture similar to those of Class 0 and Class 1 nodes. However, Class 2 nodes may include applications devices that are constrained with limitations in terms of cost and size. Class 2 nodes may be applied, for example, in devices such as door/window contacts, window contacts, temperature sensors. Such devices may be equipped with a less powerful, and therefore, for example, more economic, microcontroller as well as a smaller battery. Class 2 nodes may be arranged at the periphery (i.e. edge) of the network tree since Class 2 nodes may allow for only limited networking capabilities. For example, Class 2 nodes may not be capable of forming a multi-hop point. Battery-powered nodes not permanently a member of the network topology (Class 3 nodes) Class 3 nodes may have a general architecture similar to those of Class 0 and Class 1 nodes. However, Class 3 node may include applications devices that may be constrained, for example, by cost and size. Moreover, they may feature a RF transmitter only rather than a transceiver. Class 3 nodes may be applied, for example, in devices such as key fobs, panic buttons, or location service devices. These devices may be equipped with a less powerful, ad therefore, more economic microcontroller, as well as a smaller battery. Class 3 nodes may be configured to be a non-permanent part of the network topology (e.g., they may not be supervised and may not be eligible to form a multi-hop point). However, they may be capable of issuing messages that may be received and forwarded by other nodes in the network.

Cluster Heads

Cluster heads are dedicated network control nodes. They may additionally but not necessarily perform sensor or actuator functions. They may differ in several properties from the Class 0, 1, and 2 nodes. First, the cluster heads may have a significantly more powerful microcontroller and more memory at their disposal. Second, the cluster heads may not be as limited in energy resources as the Class 1 and 2 nodes. For example, cluster heads may have a mains (AC) power supply with an optional backup battery for a limited time in case of power blackouts (such as, for example, 72 hrs) Cluster heads may further include a short or medium range radio module (“Radio 1”) for communication with the sensor/actuator nodes. For communication with other cluster heads, cluster heads may in addition include a second RF transceiver (“Radio 2”) with a larger bandwidth and/or longer communication range, such as, for example, but not necessarily at another frequency band than the Radio 1.

In an alternative exemplary setup, the cluster heads may have only one radio module capable of communicating with both the sensor/actuator nodes and other cluster heads. This radio may offer an extended communication range compared to those in the sensor/actuator nodes.

The microcontroller of the cluster heads may be more capable, for example, in terms of clock speed and memory size, than the microcontrollers of the sensor/actuator nodes. For example, the microcontroller of the cluster heads may run several software programs to coordinate the communication with other cluster heads (as may be required, for example, by the clusterhead network), to control the sensor/actuator network, and to interpret and store information retrieved from sensors and other cluster heads (database). Additionally, a cluster head may include a standard wire-based or wireless transceiver, such as, for example, an Ethernet or Bluetooth transceiver, in order to connect to any stationary, mobile, or handheld computer (“panel”) with the same interface. This functionality may also be performed wirelessly by one of the radio modules. Each cluster head may be factory-programmed with a unique device ID.

Panel

The top-level device may include a stationary, mobile or handheld computer with a software program including for example a user interface (“panel”). A panel may be connected through the abovementioned transceiver to one cluster head, either through a local area network (LAN), or through a dedicated wire-based or wireless link.

Installation

An exemplary system may include a number (up to several hundred, for example) of cluster heads distributed over the site to be monitored and/or controlled (see FIG. 2). The installer may be required to take the precaution that the distance between the cluster heads does not exceed the transmission range of the respective radio transceiver (For example, “Radio 2”, may operate 50 to 500 meters). The cluster heads may be connected to an AC power line. Upon installation, the cluster heads may be set to operate in an inquiry mode. In this mode, the radio transceiver may continuously scan the channels to receive data packets from other cluster heads in order to set up communication links.

Between and around the cluster heads, the required sensor/actuator nodes may be installed (up to several thousand, typically 10 to 500 times as many as cluster heads). Devices with different functionality, such as, for example, different sensor types and actuators, may be mixed.

During installation, the installer should follow two general rules. First, the distance between individual sensor/actuator nodes and between them and at least one cluster head should not exceed the maximum transmission range of their radios (“Radio 1” of the cluster heads, may operate within a range of, for example, 10 to 100 meters). Second, the depth of the network, i.e., the number of hops from a node at the periphery of the network in order to reach the nearest cluster head, should be limited according to the latency requirements of the current application (such as, for example, 1 to 10 hops).

Upon installation, all sensor/actuator nodes may be set to operate in an energy-saving polling mode. In this mode, the controller and all other components of the sensor/actuator node remain in a power save or sleep mode. In defined time intervals, the radio and the network controller may be very briefly woken up by a built-in timer in order to scan the channel for a beacon signal (such as, for example, an RF tone or a special sequence).

During the installation, the unique IDs of the cluster heads (or their radio modules, respectively) as well as the unique IDs of all sensor/actuator nodes may be made known, for example, by reading a barcode on each device, triggering an ID transmission from each device through a wireless or wire-based interface, or manually inputting the device IDs via an installation tool. Once known, the unique IDs may be recorded and/or stored, as well as other related information, such as, for example, a predefined security zone or a corresponding device location. This information may be required to derive the network topology during the initialization of the network, and to ensure that only registered devices are allowed to participate in the network.

Initialization

After the installation of all nodes, at least one panel may be connected to one of the cluster heads. This may be accomplished, for example, via a Local Area Network (LAN), a direct Ethernet connection, another wire-based link, or a wireless link. Through the user interface of the panel software, a software program for performing an auto-configuration may then be started on the controller of the cluster head in order to setup a network between all cluster heads. The progress of the configuration may be displayed on the user interface, which may include an option for the user to intervene. For example, the user interface may include an option to define preferred connections between individual devices.

In a first step, the cluster head connected to the panel is provided with an ID list of all cluster heads that are part of the actual network (i.e., the allowed IDs). Then, the discovery of all links between all cluster heads with allowed IDs (e.g., using the “Radio 2” transceivers) is started from this cluster head. This may be realized by successive exchange of inquiry packets and the allowed ID list between neighboring nodes. As links to other cluster heads are established, the entries of the routing tables of all cluster heads may be routinely updated with all newly inquired nodes or new links to known nodes. The link discovery process is finished when at least one route can be found between any two installed cluster heads, no new links can be discovered, and the routing table of every cluster head is updated with the latest status.

Next, an optimum routing topology is determined to establish a reliable communication network connecting all cluster heads. The optimization algorithm may be based on a cost function including, but not limited to, message delay, number of hops, and number of connections from/to individual cluster heads (“load”). The associated routine may be performed on the panel or on the cluster head connected to the panel. The particular algorithm may depend, for example, on the restrictions of the physical and the link layer, and on requirements of the actual application.

The link discovery and routing may be performed using standardized layered protocols including, for example, Bluetooth, IEEE 802.11, or IEEE 802.15. In particular, link discovery and routing may be implemented as an application supported by the services of the lower layers of a standardized communications protocol stack. The lower layers may include, for example, a Media Access Control (MAC) and physical layer.

By using standardized protocols, standardized radio transceivers may be used as “Radio 2”. Furthermore, the use of standardized protocols may provide special features and/or services including, for example, a master/slave mode operation, that may be used in the routing algorithm.

Once the cluster head network is established, all active links may be continuously monitored to ensure connectivity by supervising the messages exchanged between neighboring nodes. Additionally, the cluster heads may synchronize their internal clocks so that they may perform tasks in a time-synchronized manner.

In the next step, an ad-hoc multi-hop network between the sensor/actuator nodes and the cluster head network is established. There may be several alternative approaches to establish the multi-hop and cluster head networks, including, for example, both decentralized and centralized approaches. To prevent unauthorized intrusion into the wireless network, all links between the cluster heads and between the sensor/actuator nodes may be secured by encryption and/or a message authentication code (MAC) using, for example, public shared keys.

a. Decentralized Approach 1

According to a first exemplary decentralized method, the cluster heads initially broadcast a beacon signal (such as, for example, an RF tone or a fixed sequence, e.g., 1-0-1-0-1- . . . ) in order to wake up the sensor/actuator nodes within their transmission range (“first layer nodes”) from the above-mentioned polling mode. Then, the cluster heads broadcast for a predefined time messages (“link discovery packets”) containing all or a subset of the following: A header with preamble, the node ID, node class and type, and time stamps to allow the recipients to synchronize their internal clocks. After the cluster heads stop transmitting, the first layer nodes begin by broadcasting beacon signals and then next broadcast “link discovery packets”. The beacons wake up a second layer of sensor/actuator nodes, i.e., nodes within the broadcast range of first layer nodes that could not receive messages directly from any cluster head. This procedure of successive transmission of beacons and link discovery packets may occur until the last layer of sensor/actuator nodes has been reached. (The maximum number of allowed layers may be a user-defined constraint.)

Eventually, all nodes may be synchronized with respect to the cluster head network. Hence, there are time slots in which only nodes within one particular layer are transmitting. All other activated nodes may receive and build a list of sensor/actuator nodes within their transmission range, a list of cluster heads, and the average cost required to reach each cluster head via the associated links. The cost (e.g., the number of hops, latency, etc.) may be calculated based on measures such as signal strength or packet loss rate, power reserves at the node, and networking capabilities of the node (see node classes 0, 1, 2). There may be a threshold of the average link cost above which neighboring nodes are not kept in the list.

Once the last layer of sensor/actuator nodes has been reached, i.e., all nodes have built their respective neighbor list, the cluster heads broadcast for a defined time another message type (“route discovery packets”) which may includes all or a subset of the following: A header with preamble, the node ID, node class and type, the cost in order to reach the nearest cluster head (e.g., set to zero cost), the number of hops to reach this cluster head (e.g., set to zero cost), and the ID of the nearest cluster head (e.g., set to its own ID). Once the cluster heads stop transmitting, the sensor/actuator nodes broadcast route discovery packets (now with cost>0, number of hops>0) in the following manner: There is one time slot for each possible cost>0, i.e. 1, 2, 3 . . . . max. Within each time slot, all nodes having a route for reaching the nearest cluster head with this particular cost broadcast several route discovery packets. All other nodes listen and update their list of cluster heads using a new cost function. This new cost function may contain the cost for the node to receive the message from the particular cluster head, the overall number of hops to reach this cluster head, and the cost of the link between the receiving node and the transmitting node (from the previously built list of neighboring nodes). Nodes having no direct link to any cluster head so far now may start to build their cluster head list. Moreover, new routes with a higher number of hops but a lower cost than the previously known routes may become available. Furthermore, all nodes continuously determine the layer of their neighboring nodes from the route discovery packets of these nodes.

Once the time slot associated with the lowest cost of an individual node to reach a cluster head has been approached, this node starts broadcasting its route discovery packets, stops updating the cluster head list, and builds a new list of neighboring nodes belonging to the next higher layer n+1 only. This procedure may ensure that every node receives a route to a cluster head with the least possible cost, knows the logical layer n it belongs to, and has a list of direct neighbors in the next higher layer n+1.

Once the last time slot for route discovery packets has been reached, all nodes may start to send “route registration packets” to their cluster heads using intermediate nodes as multi-hop points. Link-level acknowledgement packets may ensure the reliability of these transmissions. In this phase, nodes may keep track of their neighbors in layer n+1 which use them as multi-hop points: supervision packets from these nodes may have to be confirmed during the following mode of normal operation. The route registration packets may contain all or a subset of the following: A header with preamble, the ID of the transmitting node, the list of direct neighbors in the next higher layer (optionally including the associated link costs), and the IDs of all nodes which have forwarded the packet.

The cluster heads respond with acknowledgement packets (optionally including a time stamp for re-synchronization) being sent the inverse path to each individual sensor/actuator node. If there is no link-level acknowledgement, the route registration packets are periodically retransmitted by the sensor/actuator nodes until a valid acknowledgment has been received from the associated cluster head.

The cluster heads exchange and update the information about all registered nodes among each other. Hence, the complete topology of the sensor/actuator network may be derived at each cluster head.

The initialization is finished when valid acknowledgments have been received at all nodes, all cluster heads contain similar information about the network topology, and the quantity and IDs of the registered sensor/actuator nodes are consistent with the information known at the cluster heads from the installation. In case of inconsistencies, an error message may be generated at the panel and the initialization process is repeated. Once the initialization is finalized, the sensor/actuator nodes remain in a power-saving mode of normal operation (see below).

b. Decentralized Approach 2

According to a second exemplary decentralized method to establish the multi-hop and cluster head networks, the cluster heads may broadcast beacon signals during a first time slot in order to wake up the sensor/actuator nodes within their transmission range (“first layer nodes”) from the polling mode. The cluster heads then broadcast a predefined number of “link discovery packets” containing all or a subset of the following: a header with preamble, an ID, and a time stamp allowing the recipients to synchronize their internal clocks. All activated nodes may receive and build a list of cluster heads, as well as an average cost for the respective links. The cost may be calculated based on the signal strength and the packet loss rate.

After the cluster heads stop transmitting, in a second time slot the first layer nodes start broadcasting beacons and link discovery packets, respectively. The beacons wake up the second layer of sensor/actuator nodes, which were not previously woken up by the cluster heads. In addition to an ID and time stamp, the link discovery packets sent by sensor/actuator nodes may also contain their layer, node class and type, and the cost required to reach the “nearest” (i.e., with least cost) cluster head derived from previously received link discovery packets of other nodes. All activated nodes may receive and build a list of nodes in their transmission range and cluster heads, as well as the average cost for the respective links. The cost may be calculated, for example, based on number of hops, signal strength, packet loss rate, power reserves at the nodes, and networking capabilities of the nodes (see infra description for node classes 0, 1, 2). This process may continue until the nodes in the highest layer (farthest away from cluster heads) have woken up, have broadcast their messages in the respective time slot, and have built the respective node lists.

The decision of a node in layer n regarding its nearest cluster head may be based upon previously broadcasted decisions of nodes in the layer n−1 (closer to the cluster head). Should a new route including one additional hop lead to a lower cost, a node may rebroadcast its link discovery packets within the following time slot, i.e., the node is moved to the next higher layer n+1. This may result in changes of the “nearest cluster heads” for other nodes. However, these affected nodes may only need to re-broadcast in case of a layer change.

Once the nodes within the highest layer have determined their route with the least cost to one of the cluster heads, all nodes may start to send route registration packets to their nearest determined cluster head using intermediate nodes as multi-hop points. These transmissions may be made reliable via link-level acknowledgment. In this phase, the nodes keep track of their neighbors in layer n+1 which use them as multi-hop points: Supervision packets from these nodes may be confirmed during the normal operation mode that follows initialization. The route registration packets contain a header with preamble, the ID of the transmitting node, the list of neighbors in the next higher layer (optionally including the associated link costs), and the IDs of all nodes that have forwarded the packet.

The cluster heads may respond with acknowledgement packets (optionally including a time stamp for re-synchronization) sent to the individual sensor/actuator nodes along the reverse path traversed by the route registration packet. If there is no link-level acknowledgement, the route registration packets may be periodically retransmitted by the sensor/actuator nodes until a valid acknowledgment has been received from the respective cluster head.

The cluster heads may exchange and update the information about all registered nodes among each other. Hence, the complete topology of the sensor/actuator network may be derived at each individual cluster head. The initialization is finished when valid acknowledgments have been received at all nodes, all cluster heads contain similar information about the network topology, and the quantity and IDs of all registered sensor/actuator nodes are consistent with the information known at the cluster heads from the installation. In case of inconsistencies, an error message may be generated at the panel and the initialization process may be repeated. Once the initialization is finalized, the sensor/actuator nodes may remain in a power-saving mode of normal operation.

c. Centralized Approach 1

According to a first exemplary centralized method to establish the multi-hop and cluster head networks, the cluster heads broadcast beacon signals to wake up the sensor/actuator nodes within their transmission range (i.e., “first layer nodes”) from the polling mode. Then, the cluster heads broadcast messages (“link discovery packets”) for a predefined time containing a header with preamble, an ID, and time stamps allowing the recipients to synchronize their internal clocks. After the cluster heads stop transmitting, the first layer nodes may start broadcasting beacons and link discovery packets that additionally contain a node class and type. The beacons wake up the next layer of sensor/actuator nodes. This procedure of successive transmission of beacons and link discovery packets may occur until the last layer of sensor/actuator nodes has been reached. Eventually, all nodes are active and synchronized with respect to the cluster head network.

The activated nodes may receive and build a list containing the IDs and classes/types of sensor/actuator nodes and cluster heads within their transmission range, as well as the average cost of the associated links. The cost may be calculated based on signal strength, packet loss rate, power reserves at the node, and networking capabilities of the node. There may be a threshold of the average link cost above which neighboring nodes are not kept in the list.

Once the last layer of nodes has been activated, all nodes send link registration packets through nodes in lower layers to any one of the cluster heads. These transmissions may be made reliable via link-level acknowledgments. These packets contain a header with preamble, the ID of the transmitting node, the list of all direct neighbors including the associated link costs, and a list of the IDs of all nodes that have forwarded the particular packet. The cluster heads may respond by sending acknowledgement packets to the individual sensor/actuator nodes along the reverse path traversed by the registration packets.

The information received at individual cluster heads may be constantly shared and updated with all other cluster heads. Once a link registration packet has been received from every installed sensor/actuator node, the global routing topology for the entire sensor/actuator network may be determined at the panel or at the cluster head connected to it. The determined global routing topology may be optimized with respect to latency and equalized load distribution in the network. The different capabilities of the different node classes 0, 1, 2 may also be considered in this algorithm. Hence, the features of the centralized approach may include reduced overhead at the sensor/actuator nodes and a more evenly distributed load within the network. Under ideal circumstances, each cluster head may be connected to a cluster of nodes of approximately the same size, and each node within the cluster may again serve as a multi-point hop for an approximately equal number of nodes.

Eventually, a “route definition packet” may be sent from the cluster head to each individual node containing all or a subset of the following: a header and preamble, the node's layer n, its neighbors in higher layer n+1, the neighbor in layer n−1 to be used for message forwarding, the cluster head to report to, and a time stamp for re-synchronization. The route definition packet may be periodically retransmitted until the issuing cluster head receives a valid acknowledgment packet from each individual sensor/actuator node. The reliability of the exchange may be increased by link-level acknowledgements at each hop. Once acknowledged, this information may be continuously shared and updated among the cluster heads.

The initialization may be completed when valid acknowledgments have been received at the cluster heads from all sensor/actuator nodes, all cluster heads contain the same information regarding the network topology, and the quantity and IDs of all registered nodes is consistent with the information known from the installation. In case of inconsistencies, an error message may be generated at the panel and the initialization process is repeated. Once the initialization is finalized, the sensor/actuator nodes remain in a power-saving mode of normal operation.

Operation

Cluster Head Network

To eliminate a central base station as a single point of failure, and to make complex and large network topologies possible without an excessive number of hops (message retransmissions) and with low latency all cluster heads may maintain consistent information of the entire network. In particular, the cluster heads may maintain consistent information regarding all other cluster heads as well as the sensor/actuator nodes associated with them. Therefore, the databases in each cluster head may be continuously updated by exchanging data packets with the neighboring cluster heads. Moreover, redundant information, such as, for example, information about the same sensor/actuator node at more than one cluster head, may be used in order to confirm messages.

Since the information about the status of the entire network is maintained at every cluster head, the user may simultaneously monitor the entire network at multiple panels connected to several cluster heads, and may use different types of panels simultaneously. According to one exemplary embodiment, some of the cluster heads may be connected to an already existing local area network (LAN), thus allowing for access from any PC with the panel software installed. Alternatively, remote control over a, for example, secured Internet connection may be performed.

Since a local area network (LAN) or Internet server may still represent a potential single point of failure, at least one dedicated panel computer may be directly linked to one of the cluster heads. This device may also provide a gateway to an outside network or to an operator. Moreover, a person carrying a mobile or handheld computer may link with any of the cluster heads in his or her vicinity via a wireless connection. Hence, the network may be controlled from virtually any location within the communication range of the cluster heads.

Sensor/Actuator Network

During normal operation, the sensor/actuator nodes may operate in an energy-efficient mode with very low duty cycle. The transceiver and the microcontroller may be predominantly in a power save or sleep mode. In certain intervals (such as, for example, every ten milliseconds up to every few minutes) the sensor/actuator nodes may wake up for very brief cycles (such as, for example, within the tens of microseconds to milliseconds range) in order to detect RF beacon signals, and to perform self-tests and other tasks depending on individual device functionality. If a RF beacon is detected, the controller checks the preamble and header of the following message. If it is a valid message for this particular node, the entire message is received. If no message is received or an invalid message is received, timeouts at each of these steps allow the node to go back to low power mode in order to preserve power. If a valid message is received, the required action is taken, such as, for example, a task is performed or message is forwarded.

If the sensor or the self-test circuitry detects an alarm state, an alarm message may be generated and broadcasted, which may be relayed towards the cluster heads by intermediate nodes. Depending on the actual application, the alarm-generating node may remain awake until a confirmation from a neighboring node or from one of the cluster heads or a control message from a cluster head has been received. By using this mechanism of “directed flooding”, alarm messages may be forwarded to one or more of the cluster heads by a multihop operation through intermediate nodes. This may ensure redundancy and quick transfer of urgent alarm messages. Alternatively, in less time-critical applications and for control messages sent from the cluster heads to individual nodes, the packets may be unicasted from node to node in order to keep the network traffic low.

In order to keep track of the status of the individual sensor/actuator nodes and the links between them, all nodes may synchronously wake up (such as, for example, within time intervals of several minutes to several hours) for exchange of supervision messages. In order to keep the network traffic low and to preserve energy at the nodes, data aggregation schemes may be deployed.

According to one exemplary embodiment, nodes closer to a cluster head (i.e., the lower-layer nodes) may wait for the status messages from the nodes farther away from the cluster head (i.e., the higher-layer nodes) in order to consolidate information into a single message. To reduce packet size, only “not-OK status” information may explicitly be forwarded. Since the entire network topology is maintained at each of the cluster heads, this information may be sufficient to implicitly derive the status of every node without explicit OK-messages. By doing so, a minimum number of messages with minimum packet size may be generated. In an optimum case, only one brief OK message per node may be generated.

In order to ensure that the status of each node is sent to at least one cluster head during every supervision interval, the status messages may be acknowledged by the receiving lower-layer nodes. The acknowledgment packets may also contain a time stamp, thus allowing for successive re-synchronization of the internal clocks of every sensor/actuator node with the cluster head network.

Furthermore, the nodes may implicitly include the status information (e.g., not-OK information only) of all lower-layer nodes within their hearing range in their own messages, i.e., also of nodes which receive acknowledgments from other nodes and even report to other cluster heads. This may lead to a high redundancy of the status information received by the cluster heads. Since the entire network topology may be maintained at the cluster heads, this information may be utilized to distinguish between link and node failures, and to reduce the number of false alarms. Confirmation messages from the cluster heads or from neighboring nodes may also be used for resynchronization of the clocks of the sensor/actuator nodes.

Reconfiguration

In case of a failure of individual nodes or links in the sensor/actuator network, the network may reconfigure without user intervention so that links to all operable nodes of the remaining network may be re-established.

In an exemplary decentralized approach, this task may be performed by using information about alternative (“second best”) routes to one of the cluster heads derived and stored locally at the individual sensor/actuator nodes. Additionally, lost nodes may use “SOS” messages to retrieve a valid route from one of their neighbors.

Alternatively, in an exemplary centralized approach the cluster heads may provide disconnected sensor/actuator nodes with a new route chosen from the list of all possible routes maintained at the cluster heads. Moreover, a combination of both approaches may be implemented into one system in order to increase the speed of reconfiguration and to decrease the necessary packet overhead in the case of small local glitches.

For either approach, in case of a severe failure of several nodes, some or all cluster heads may start a partial or complete reconfiguration of the sensor/actuator network by sending new route update packets.

In case of a link failure within the cluster head network, alternative routes may immediately be established when all cluster heads maintain a table with all possible links. However, in case of a failure of one or more cluster heads a reconfiguration of the according sensor/actuator nodes may be required to reintegrate them into the network of remaining cluster heads. Since all cluster heads are configured to have complete knowledge about the entire network topology, a majority of the network may remain operable despite failure of several cluster heads or links by fragmenting into two or more parts. In this instance, the information about the nodes in each of the fragments may still be available at any of the cluster heads in this fragment.

What is claimed is:

1. A wireless network, comprising:
a cluster head network having at least one cluster head; and
a sensor/actuator network arranged in a hierarchical manner with the cluster head network and having a plurality of sensor/actuator nodes arranged in a plurality of node levels and being self-organizing.

2. The wireless network of claim 1, wherein the wireless network does not include a single point of failure.

3. The wireless network of claim 1, wherein the wireless network does not include a central base station.

4. The wireless network of claim 1, where the at least one cluster head includes redundant information regarding the wireless network as compared to another cluster head.

5. The wireless network of claim 4, wherein the redundant information is accessible by user at any of the at least one cluster head.

6. The wireless network of claim 5, wherein the wireless network is configured so that the user interacts with at least one of the at least one cluster head and the redundant information.

7. The wireless network of claim 1, wherein the at least one cluster head is configured to one of control and supervise the sensor/actuator nodes so that a task is performed by any cluster head.

8. The wireless network of claim 1, wherein the wireless network is configurable without at least one of user interaction and detailed planning.

9. The wireless network of claim 1, wherein the wireless network is reconfigurable despite at least one of a link failure and a sensor/actuator node failure.

10. The wireless network of claim 1, wherein the useful lifetime of the wireless network is optimized.

11. The wireless network of claim 1, wherein the wireless network is applied for at least one of security, home automation, climate control, and control and surveillance.

12. The wireless network of claim 1, wherein the at least one cluster head includes a base station.

13. The wireless network of claim 1, wherein the sensor/actuator nodes includes a sensor element.

14. The wireless network of claim 13, wherein the sensor element includes at least one of a smoke detector, a motion detector, a temperature sensor, and a door/window contact.

15. The wireless network of claim 1, wherein the sensor/actuator nodes include an actuator.

16. The wireless network of claim 15, wherein the actuator includes at least one of an alarm sounder and a valve actuator.

17. The wireless network of claim 1, wherein the sensor/actuator nodes include a power-line powered node.

18. The wireless network of claim 17, wherein the power-line powered node is configured to serve as a multi-hop point.

19. The wireless network of claim 17, wherein the power-lined powered node includes a backup power supply.

20. The wireless network of claim 1, wherein the sensor/actuator nodes include a battery-powered node.

21. The wireless network of claim 20, wherein the battery-powered node includes at least one of a solar cell and an electro-ceramic generator.

22. The wireless network of claim 20, wherein the battery-powered node is configured to serve as a multi-hop point.

23. The wireless network of claim 1, wherein the sensor/actuator nodes include a battery-powered node with limited capabilities.

24. The wireless network of claim 1, wherein the cluster head includes a first radio module to communicate with the sensor/actuator nodes and a second radio module to communicate with other cluster heads.

25. The wireless network of claim 1, wherein the at least one cluster head includes a single radio module to communicate with the sensor/actuator nodes and with other cluster heads.

26. The wireless network of claim 1, wherein the at least one cluster head includes one of a standard wire-based or a standard wireless transceiver.

27. The wireless network of claim 1, wherein the at least one cluster head includes at least one of an Ethernet and a Bluetooth transceiver.

28. The wireless network of claim 1, further comprising:
a panel connected to the cluster head network.

29. The wireless network of claim 28, wherein the panel is connected to the cluster head network via at least one of a local area network, a dedicated wire-based link, and a dedicated wireless link.

30. The wireless network of claim 28, wherein the panel includes software to auto-configure the at least one of the cluster head network and the sensor/actuator node network.

31. The wireless network of claim 28, wherein the panel includes a personal computer.

32. The wireless network of claim 1, wherein the sensor/actuator nodes are configured to operate in an energy-saving polling mode.

33. The wireless network of claim 1, wherein the sensor/actuator nodes are configured to be woken up by a built in timer to scan a channel for a beacon signal.

34. The wireless network of claim 33, wherein the beacon signal is one of a RF tone and a special sequence.

35. The wireless network of claim 1, wherein the at least one cluster head and the sensor/actuator nodes include a unique identifier.

36. A method of wirelessly networking sensor/actuator nodes, comprising:
initializing a cluster head network;
initializing a sensor/actuator node network to form an integrated wireless network, the sensor/actuator nodes forming a plurality of node levels; and
operating the integrated wireless network.

37. The method of claim 36, wherein the step of initializing the cluster head network further includes:
providing a cluster head with a list of identifiers of cluster heads of the cluster head network;
discovering links between the cluster heads by exchanging inquiry packets and the list of identifiers;
updating entries of routing tables; and
determining an optimum topology based on at least one of message delay, a number of hops, and connections between the cluster heads.

38. The method of claim 36, wherein the step of initializing the sensor/actuator node network further includes:
transmitting beacon signals and link discovery packets from cluster heads to a first layer of sensor/actuator nodes to wakeup the first layer of sensor/actuator nodes and to gather link information;
successively transmitting the beacon signals and link discovery packets from the lower layer nodes to the higher layer nodes to wakeup the higher layer nodes and to gather the link information; and
transmitting route discovery packets to the sensor/actuator nodes;
transmitting route registration packets to the cluster heads including the link information; and
sharing the link information with all cluster heads of the cluster head network.

39. The method of claim 36, wherein the step of initializing the sensor/actuator node network further includes:
successively transmitting beacon signals and link discovery packets to each of the node levels to wakeup the sensor/actuator nodes and to gather link information;
registering the sensor/actuator nodes by sending the link information to the cluster head network; and
sharing the link information with all cluster heads of the cluster head network.

40. The method of claim 36, wherein the step of operating the integrated wireless network further includes:
continuously sharing link information among the cluster heads of the cluster head network; and
operating the sensor/actuator nodes in an energy-efficient mode.

41. The method of claim 40, wherein the step of operating the sensor/actuator node further includes:
waking-up the sensor/actuator nodes for a brief cycle to one of detect beacon signals, perform a self-test, and perform a task.

42. The method of claim 36, further comprising:
reconfiguring the sensor/actuator network in case of one of a link failure and a node failure.

43. The method of claim 42, wherein the reconfiguring step further includes:
determining an alternate route according to link information stored at a sensor/actuator node.

44. The method of claim 42, wherein the reconfiguration step further includes:
transmitting a SOS message to a neighbor sensor/actuator node of a lost sensor/actuator node to retrieve link information stored at the neighbor sensor/actuator node regarding the lost sensor/actuator node.

45. The method of claim 42, wherein reconfiguration step further includes:
determining an alternative route according to the link information stored at the cluster head.

46. The method of claim 42, wherein the reconfiguration step further includes:
fragmenting the integrated wireless network into more than one segment.
